(19) United States
(12) Patent Application Publication
(10) Pub. No.: US 2006/0123016 A1
(43) Pub. Date: Jun. 8, 2006

(54) Metadata driven method and apparatus to configure heterogenous distributed systems

(75) Inventors: Rohith Kottamangalam Ashok, Apex, NC (US); Michael Cheng, Austin, TX (US); Vishwanath Venkataramappa, Austin, TX (US); Qinhua Wang, Austin, TX (US)

Correspondence Address: IBM CORPORATION (SWP);C/O SUITER WEST SWANTZ PC LLO, 14301 FNB PARKWAY, SUITE 220, OMAHA, NE, 68154-5299, US

(73) Assignee: INTERNATIONAL BUSINESS MACHINES CORPORATION, ARMONK, NY (US)

(21) Appl. No.: 11/002,696

(22) Filed: Dec. 2, 2004

(51) Int. Cl. G06F 7/00

(52) U.S. Cl. 707/100

(57) ABSTRACT

A meta-data driven method and apparatus to manage configurations of coexisting heterogeneous subsystems. The present invention recognizes that schemas evolve incrementally from version to version. In a preferred embodiment, the present invention employs two stages: an identification specification stage, to identify and/or specify any changes in a heterogeneous distributed system, and a configuration validation stage, to implement and/or validate the changes thus identified or specified. In the first stage, the identification specification stage, the present invention programmably compares the next version of the schema from its previous version. This allows meta-data to be created that describes how a schema component evolves from version to version. In addition, a user may specify what appears in the schema. In the second stage, the configuration validation stage, the meta-data created in the first stage can be used to determine whether a particular component version of the subsystem is valid for a particular schema component, and vice versa, and/or to configure the subsystem to conform to the schema.

### FIELD OF THE INVENTION

The present invention relates generally to the fields of computer management and configuration of subsystems by an administrator, information rights management and authentication.

### BACKGROUND OF THE INVENTION

Distributed systems are computer systems (a system comprising I/O, memory, processors and the like) that are networked throughout a geographical area. A distributed system typically is composed of a number of subsystems, controlled by a system administrator (e.g., a system administrator of a system may control various users of the subsystems who may have fewer permissions and control over the system than the administrator). The systems and subsystems may be configured as clients in a N-tier client/server relationship, in a peer-to-peer relationship, or some other combination. Such subsystems may reside on different hosts in the network, and more than one subsystem may co-exist on the same host.

It is advantageous for an administrator to centrally manage and configure the subsystems. Further, the administrator may perform operations based on the relationships among the subsystems. For example, the administrator can subdivide common subsystems into groups. To change the configuration or state of subsystems en masse, operations may be applied to groups, rather than to each subsystem individually, to prevent information overload by the administrator, and to allow the scaling of the administration of the subsystems.

An incorrectly configured subsystem can misbehave or crash. It is thus important to validate the configurations of each subsystem. However, it is a challenge to design an administrative tool to enforce the validation. Present solutions implement separate logic to account for subsystem differences. This approach, however, does not scale well when the number of versions and the number of subsystems increase. Not only does the required development effort by programmers multiply, this approach is prone to produce erroneous code. A more systematic, scalable approach is desired.

The complexity in validating the configurations of subsystems lies in the number of possible permutations as subsystems evolve. Each subsystem may be customized through a configuration schema. Except for the simplest of schemas, each schema that configures a subsystem can be further subdivided into schema components that map to some runtime components within the subsystem. As a subsystem evolves, a new version of a schema having changes may be distributed. These schema changes, which complicate configuration and validation of a subsystem, may include:
adding a new schema component: the schema component did not previously exist, or it was previously invalidated;
conditionally making a schema component valid based on constraints placed by certain subsystem features. This may be based on actual features installed in the subsystem, or the actual operating system features, or some other prerequisites;
   deprecating a schema component: the schema component is still valid now, but will become invalid in the near future;
invalidating a schema component: the schema component is no longer valid in the subsystem;
changing the allowed values for a schema component;
coordinating changes among subsystems: (1) moving a schema component from one subsystem to another, by invalidating the schema component in one subsystem, and adding it to another; (2) sharing a schema component, by adding a schema component to one or more subsystems; (3) unsharing a schema component, by invalidating a schema component in all but one subsystem.

Factoring all of the above, it can be seen that the complexity of configuration management of subsystems with schemas increases quickly. Even with just two to three coexisting subsystems, it is difficult to handcraft the configuration validation logic necessary. What is needed is a superior method and apparatus to configure heterogeneous distributed systems.

### SUMMARY OF THE INVENTION

Accordingly, an aspect of the present invention is to provide an improved, scalable, method and apparatus to configure heterogeneous distributed systems.

The present invention uses a meta-data driven method and apparatus to manage configurations of coexisting heterogeneous subsystems. The present invention recognizes that schemas evolve incrementally from version to version. In a preferred embodiment, the method and apparatus of the present invention employs a software tool running on a computer.

The present invention employs two stages: an identification specification stage, to identify and/or specify any changes in a heterogeneous distributed system, and a configuration validation stage, to implement and/or validate the changes thus identified or specified.

In the first stage, the identification specification stage, the present invention programmably compares the next version of the schema from its previous version. This allows meta-data to be created that describes how a schema component evolves from version to version. In addition, a user (e.g., administrator) may specify what appears in the schema by adding additional metadata not automatically captured programably by the tool.

In the second stage, the configuration validation stage, the meta-data created in the first stage can be used to determine whether a particular component version of the subsystem is valid for a particular schema component, and vice versa, and/or to configure the subsystem to conform to the schema.

The advantage of the present invention is that it is scalable, flexible and extensible. The present invention is scalable because the logic used in the configuration validation stage needs no prior knowledge of the configuration schema. As the number of versions, subsystems, or subsystem features increases, no change to the validation knowledge is required. The present invention is flexible because the schema for each subsystem may be changed without affecting the validation logic. The present invention is extensible because validation of a new subsystem may be extended simply by generating a new set of meta-data for the new subsystem.

The method and apparatus of the present invention is a computing platform running a software tool, which can accept human input, and may be written in any computer language (such as C, C++, Perl, Java or the like) run by a computer system having an operating system. The computer system typically has one or more processors, primary and secondary memory cooperating with the processor(s), which executes instructions stored in the memory, an Operating System (OS), I/O means such as monitor, mouse and keyboard, and any necessary specialized hardware or firmware. Depending on the language used to construct and implement the software tool, the source code, object code and/or executable code of the tool may have any number of classes, functions, objects, variables, templates, lines of code, portions of code and constructs (collectively and generally, “a process step”, “step”, “block”, “functional module” or “software module”) to carry out the invention in successive stages as described and taught herein, and may be either a standalone software application, or employed inside of or called by another software application, or as firmware. The software process or software module may be constructed so that one portion of code in the application performs a plurality of functions, as for instance in Object Oriented programming (e.g., an overloaded process). The converse is also true, in that a plurality of portions of code could perform a plurality of functions, and still be functionally the same as a single portion of code. At any stage of the process step of the present invention, intermediate values, variables and data may be stored for later use by the program. In addition, the binary executable or source code data comprising the software of the present invention may reside on computer readable storage medium (e.g., a magnetic disk, which may be portable, such as a hard drive, floppy drive; memory (e.g., flash RAM); or a CD-ROM disk).

The sum total of all of the above advantages, as well as the numerous other advantages disclosed and inherent from the invention described herein creates an improvement over prior techniques.

The above described and many other features and attendant advantages of the present invention will become apparent from a consideration of the following detailed description when considered in conjunction with the accompanying drawings.

### BRIEF DESCRIPTION OF THE DRAWINGS

The numerous advantages of the present invention may be better understood by those skilled in the art by reference to the accompanying figures in which:

FIG. 1 is a flowchart showing the identification—specification stage of a preferred embodiment of the present invention, where meta-data captures changes to schema components; and,

FIG. 2 is a flowchart showing the configuration—validation stage of a preferred embodiment of the present invention, where a particular schema component or schema configuration may be checked for validity with a particular version of a subsystem and/or to configure the subsystems using the schema.

### DETAILED DESCRIPTION OF THE INVENTION

The present invention is to configure heterogeneous distributed systems. These systems may be any computer system such as a personal computer, personal digital assistant, mainframe computer, wireless telephone, web server, or any electronic device of any kind having electronic components and communicating with another electronic device of any kind. As explained herein, heterogeneous distributed systems are comprised of subsystems. Each subsystem has a set of features, which may be thought of as state variables, or subsystem features (configuration variables) that uniquely or as completely as possible describe the subsystem. For example, these state variables of a subsystem may include, but are not limited to, variables that identify a subsystem such as: operating system name, version number of one or more pieces of software (threads, processes, kernels and the like), firmware in the subsystem, hardware components in the subsystem (e.g., type of hard drive, memory, IO devices), or data (e.g. MAC address, Internet address, digital signature stored in the subsystem), and the like. The state variables can also be variables that describe a particular subsystem in real time, such as variables that map to runtime components or processes within the subsystem. The state variables may be defined during installation of the subsystem and stored in permanent memory of the subsystem, or, the state variables may be added at any time during the life of the subsystem. The state or configuration variables simply attempt to uniquely identify or capture a snapshot of each subsystem having one or more subsystem components or subsystem features, singularly and collectively, subsystem feature components (e.g., subsystem hardware components such as a particular hard drive, or subsystem software components such as a particular kernel in an OS, or a subsystem feature such as having a particular version of software on the subsystem). These subsystem feature components may change over time.

Ultimately, the goal of the invention is to identify the state variables, subsystem features or configuration variables that adequately describe the subsystem feature components, store these state variables as meta-data (data about data), and then map this meta-data onto a configuration schema which describes a particular state or configuration of a subsystem (i.e., a particular set of subsystem feature components for one or more subsystems). Then, any changes to the configuration schema can be detected, showing that the configuration of the heterogeneous distributed system has changed (i.e., one or more subsystem feature components have changed over time). Thus, one main idea of the invention is: 1) Schema and changes in schema are captured automatically (programmatically) in the meta-data; 2) State variables and how they place constraint on how the schema is applied to the subsystem is also captured in the meta-data; 3) The meta-data is used to determine whether or not a specific configuration may be applied to a specific subsystem.

In addition to this “bottom-up” approach, where changes are detected programmatically, changes can also be applied “top-down” manually for the distributed system. For example, an administrator can specify whether or not a schema component has been deprecated.

Finally, if a new version of a schema is used to reconfigure a component or a subsystem, the tool may be used update the metadata with information about the new schema, and the constraints under which to apply the new schema.

To this end, a preferred embodiment of the invention employs two stages: (1) the identification—specification stage, to identify and/or specify the state variables and schema subcomponents of the subsystem in the heterogeneous distributed system, and changes in the state variables and schema subcomponents, and how the state variables place a constraint on how the schema subcomponents may be used to configure the subsystem; and, (2) the configuration—validation stage, to validate and/or implement the changes in the subsystems of the heterogeneous distributed system thus identified and/or specified. It is understood from the teachings of this invention that the process of identifying a change in the state variables is not necessarily limited to passive observance of these variables but could mean actively specifying what the state variables should be, such as in the case of a system administrator who wants to make changes to subsystem components on a global basis.

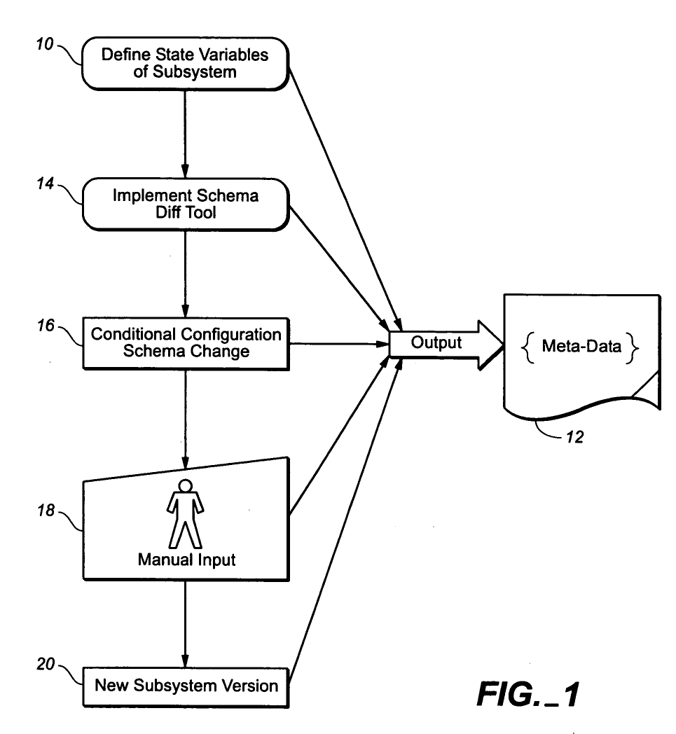

Turning now to FIG. 1, there is shown a flowchart showing the identification—specification stage of a preferred embodiment of the present invention, where meta-data stores schema components that capture any changes to and/or specify changes to the components in a subsystem that may be part of a heterogeneous distributed system. Generally this portion of the tool is termed the “schema diff tool” portion (for subsystem/schema differential tool).

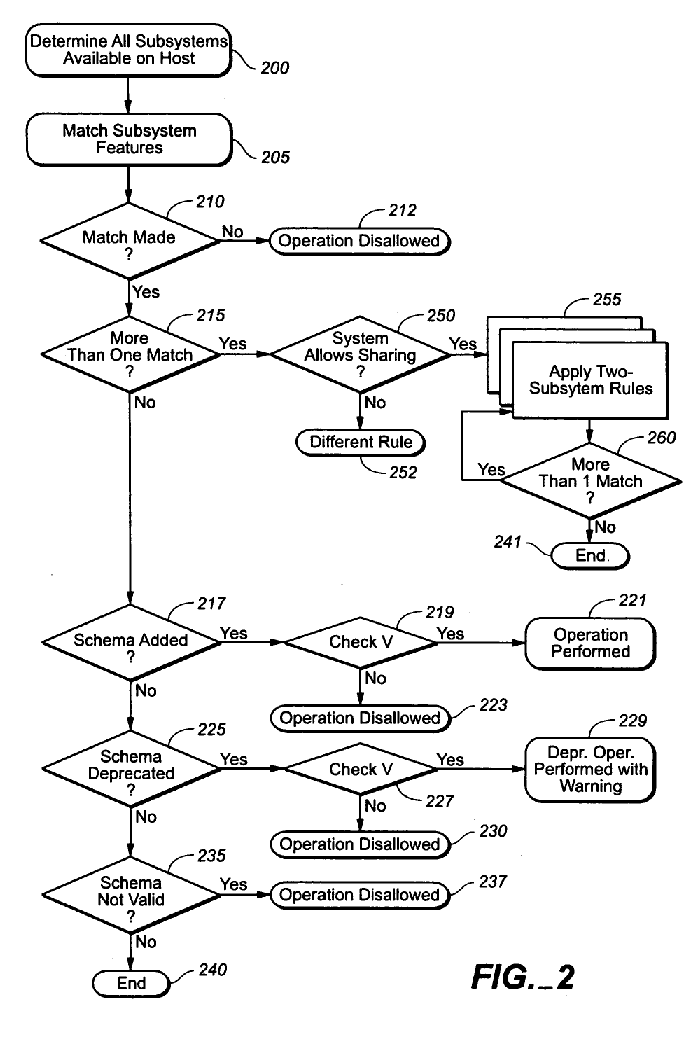

Though arrows are shown in FIGS. 1 and 2 going from box to box or step to step, it should be understood by one skilled in the art from the teachings of the present invention that the order of steps and program flow in any actual program could vary from what is shown in the figures, in particular an object oriented language program where rigid flow is often secondary to the creation of objects that handle messages in a dynamic manner, without departing from the scope of the invention. First, the software tool of the present invention would perform a step shown in FIG. 1 as block 10, labeled “Define State Variables Of Subsystem” of identifying a set of state variables, subsystem features, that uniquely identify the subsystem at a given point in time, akin to taking a snapshot of the subsystems comprising the heterogeneous distributed system. It is understood that each subsystem comprising a heterogeneous distributed system would be identified in this way. These state variables may be stored in meta-data as shown by the arrow leading to block 12 labeled “Meta-Data”. In a preferred embodiment the meta-data is in the form of an XML file. The values of the state variables may also be stored as part of metadata, or derived at runtime.

Another step, shown in FIG. 1 as block 14, labeled “Implement Schema Diff Tool,” would then include identifying any changes (made after identification of the state variables of the subsystems in the step of block 10) in the configuration schema of the subsystem in the heterogeneous distributed system. Such a change can be the result of: addition of a schema (or subsystem) component (e.g., by a system administrator and/or end user); deprecation of a schema component (schema or subsystem component valid now but soon to be invalid); invalidation of a schema component; modification of an existing schema (or subsystem) component; deletion of a schema (or subsystem) component; or changes in the allowed value of a schema component. These data that identify changes (if any) of the subsystem(s) of the distributed system would be output and stored in meta-data as shown by the arrow leading to block 12 labeled “Meta-Data”.

A further optional step would include identifying any configuration schema change (i.e. change in subsystem features) that is conditional, that is, the validity is based on the presence or absence of some other subsystem features or state variables. Thus the dependency of the subsystem features may be expressed as either valid with the existence of a subsystem feature (e.g., a new schema or subsystem component is valid only when the subsystem is installed with a particular operating system), or, the non-existence of a subsystem feature (e.g., a new schema component is valid only when the subsystem is not installed with a particular operating system). A more complicated dependency can be expressed through logical operations on subsystem features. For example, a new schema component is valid only when feature “A” is present, and feature “B” is not present, which can be expressed by the XOR (exclusive-or) logical operator. Dependency can also be expressed more efficiently by applying pattern matching on subsystem features.

This step of conditional changes in the schema is shown in FIG. 1 as block 16, labeled “Conditional Configuration Schema Change” Any such data for conditional schema changes of the subsystem(s) of the distributed system would also be stored as output in the meta-data for each subsystem as shown by the arrow leading to block 12 labeled “Meta-Data”.

Another optional step would include user intervention, shown in FIG. 1 as block 18, labeled “Manual Input”. User or manual intervention may be required to add missing information if the configuration schema does not contain enough information for the schema diff tool to generate proper meta-data information. For example, a user may have to specify which schema/subsystem components are deprecated (components valid for now, but to be invalid in the future), in case the configuration schema does not contain the necessary deprecation information. By way of another example, in no way limiting, a user may need to specify operating system dependencies of a schema component, perhaps for legal licensing reasons. Any such user intervention data of the subsystem(s) of the distributed system would also be stored as output in the meta-data for each subsystem as shown by the arrow leading to block 12 labeled “Meta-Data”.

Finally, an additional optional step may be added, as shown in block 20, so that additional meta-data regarding configuration schema changes can be generated with the schema diff tool shown by FIG. 1 whenever a brand new subsystem or a newer version of an existing subsystem is introduced into the heterogeneous distributed computer system. This step can be performed by the software at any time to account for new subsystems being added dynamically in real time. This step is shown in FIG. 1 as block 20, labeled “New Subsystem Version”. Any data produced by this portion of the tool would be output and stored in the meta-data for each subsystem as shown by the arrow leading to block 12 labeled “Meta-Data”.

At block 12, labeled “Meta-Data” in FIG. 1, the schema diff tool may merge all the meta-data into further meta-data to capture the changes to schema components in subsystems of the distributed computer system. This meta-data is used later by the tool of the present invention to validate and/or configure any new subsystem, as explained in connection with FIG. 2.

Turning attention now to FIG. 2, there is shown a flowchart of the configuration/validation stage of a preferred embodiment of the present invention, where a particular schema component or schema configuration (a schema) may be checked for validity with a particular version of a subsystem, and optionally, changes may be made to the configuration of a subsystem. That is, a particular schema (e.g., a particular designated configuration of a subsystem, including but not limited to a hardware and/or software profile, including possibly runtime components within the subsystem) is checked, typically by a system administrator, but it could be any user or even an automated system, to see if any subsystem within a heterogeneous distributed system has this particular schema and/or to make changes to any subsystem so that it conforms to this particular schema. For example, an administrator may try to configure a schema having a schema component “C” with value “V” on some subsystem. The schema component “C” may have a plurality of subsystem features associated with it, and these features would be stored in the meta-data as outlined by the present invention in connection with FIG. 1. The configuration validation phase of the present invention as represented by FIG. 2 would try and see if any of the actual subsystems have this schema component. If so, the system administrator may be satisfied that the subsystems have this schema component “C” (e.g., the actual subsystems have not been altered); or, if not, the administrator may download components or otherwise upgrade one or more of the actual subsystems to make them conform to the schema so they have schema component “C”. Once the schema component “C” is present on the subsystem, further checks via the metadata may be performed to ensure that value “V” is allowed for schema component “C” for this subsystem, given the subsystem features present, before actually effecting the change. (e.g., setting component “C” to “V” is allowed if an operating system version=version 1.0)

Thus, as shown in FIG. 2 as block 200, labeled “Determine All Subsystems Available On Host”, the first step of the configuration validation stage of the program tool is to determine the configuration and state of all the subsystems available on a host of the particular distributed system under question. This state information, as outlined herein, would include the state variables of the subsystems, e.g. information such as subsystem names and versions. Information obtained at this stage may be saved by the program as metadata, preferably as an XML file saved on a hard drive, or saved at runtime in memory.

The tool then proceeds to block 205, labeled “Match Subsystems Features”, to match or find an association or nexus between the schema change of component “C” against the actual subsystem schema features (subsystem component features) present on the host. For performance reasons, if the current version of the subsystem does not have a schema change regarding “C”, but an earlier version does, the schema change for the earlier version of the subsystem (including all its subsystem feature dependencies) may be assumed to carry forward to the current version.

If there is no match, as shown in the “No” branch of decision block 210, the configuration validation operation ends and the program ends, as indicated by block 212, labeled “Operation Disallowed”, with suitable notice given to the user of the tool. The absence of a match means there is no association or nexus between any schema component “C” against any subsystem component. This may imply a systematic error, such as where one were to try and find a match between totally dissimilar electronic equipment and components having no similar architecture, such as a match between a mainframe computer and a wireless telephone. Or this may be because the component has not been installed on the subsystem, in which case the administrator has the option of upgrading the system or subsystem so that the component is present.

If there is one match, the meta-data is used to determine whether the configuration operation may be performed. As stated above, the categories for adding, deprecating and invaliding are as follows: adding a new schema component—the schema component did not previously exist on the subsystem (i.e., no subsystem feature component is associated with the schema component), or it was previously invalidated; deprecating a schema component—the schema component is still valid now, but will become invalid in the near future; invalidating a schema component—the schema component is no longer valid in the subsystem.

In all cases of a match, if the meta-data associated with the schema, as outlined in connection with FIG. 1, specifies certain allowed values of the schema component, i.e., a value “V”, then the program checks to see whether the values of the subsystem and the allowed value “V” are within the permissible range of values. If they are, then the configuration operation (if changes to the actual subsystem are called for) is allowed to proceed; if not, the configuration operation is not allowed. In this way the program can ensure that stale or obsolete components are not added to a subsystem.

The configuration operation in the case of one match, as indicated by the “No” branch of the conditional block 215 in FIG. 2, is as follows, which may be implemented in the source code of the tool by suitable logic, e.g., such as a CASE statement:

(1) if the schema component “C” is added then the operation is performed (e.g., the actual subsystem(s) is upgraded so that schema component “C” forms a new subsystem feature component and so the subsystem now has the schema component “C” present), after checking to see if any allowed value “V” is within range, shown in FIG. 2 as boxes 217 and 219 (labeled “Check V”), 221 (labeled “Operation Performed”) and 223 (labeled “Operation Disallowed”);

(2) if the schema component “C” is deprecated (i.e., the schema component “C” is still valid now in the subsystem, but will become invalid in the near future) then the operation is performed, after checking to see if any allowed value “V” is within range, but deprecated with a warning to the end user, i.e., as shown in the flow of FIG. 2 as boxes 225 (labeled “Schema Deprecated”), 227 (labeled “Check V”), 229 (labeled “Depr. Oper. Performed with Warning”), and 230 (labeled “Operation Disallowed”));

(3) if the schema component “C” is no longer valid (invalidated) in the subsystem, then the operation cannot be preformed (shown in FIG. 2 as boxes 235, 237).

At the end of all possibilities, the program ends (e.g. as shown in FIG. 2 as box 240). The end of the program, such as at boxes 240 or 241 would also be the result when the tool validates a subsystem and ascertains that the schema components match the subsystem features even if no operation (such as schema added, schema deprecated, or schema no longer valid) is performed. Suitable notice may be given to a user of the tool. Note that the end condition at box 240 implies a systematic error in the metadata, since in its current presentation, a schema component can only be “added”, “deprecated”, or “invalidated”, and yet none matched in the metadata. By contrast, as explained further below, end condition 241 implies all rules have been applied, and the result is the transitive closure of applying the two-subsystem rule. In general, concerning the program flow for the “No” branch of box 2004, more than just the three illustrative operations (“added”, “deprecated” or “invalidated” can be expressed, as taught herein)

Turning attention now in FIG. 2 to the branch labeled “Yes” in block 200-4, labeled “More Than One Match?” there is addressed the situation where there may be more than one match, such as may occur when multiple subsystems share the same schema component (i.e., subsystem feature component, such as a shared piece of hardware or software) or the validity of the schema component depends on different sets of subsystem features or logical operations on these subsystem features.

When there are multiple matches, a disambiguating rule must be applied as to whether or not to allow the configuration (e.g., upgrade) of the actual subsystems. There can be several such rules, depending on the semantics of the system (represented in FIG. 2 by decision boxes 250 and 252).

For example, a system that allows for two subsystems to share the same schema component may use the following rule (represented in FIG. 2 by box 255) outlined below when there is a multiple match for two different subsystems. As stated above, the categories for adding, deprecating and invaliding are as follows: adding a new schema component—the schema component did not previously exist on the subsystem, or it was previously invalidated; deprecating a schema component—the schema component is still valid now, but will become invalid in the near future; invalidating a schema component—the schema component is no longer valid in the subsystem.

The configuration operation validation logic in the case of more than one match is as follows, which may be implemented in the source code of the tool by suitable logic, e.g., such as a CASE statement.

A preferred disambiguating rule for a two subsystem multiple match, shown in box 255 in FIG. 2, is (in the ordered pair operations below assume the first member, x, of the ordered pair {x, y} configuration operation belongs to the first subsystem X found with a match and the second member, y, of the ordered pair belongs to the second subsystem Y found with a match):

a. {added, added}—added, the configuration operation may be performed

b. {added, deprecated}—added, the configuration operation may be performed

c. {added, invalidated}—added, the configuration operation may be performed

d. {deprecated, added}—added, the configuration operation may be performed

e. {deprecated, deprecated}—deprecated, the configuration operation may be performed, with a warning to the user

f. {deprecated, invalidated}—deprecated, the configuration operation may be performed

g. {invalidated, added}—added, the configuration operation may be performed

h. {invalidated, deprecated}—deprecated, the configuration operation may be performed with a warning

i. {invalidated, invalidated}—invalidated, the configuration operation may not be performed

The above disambiguating rules are for purposes of illustration and not by way of limitation.

As indicated by boxes 250 and 252 in FIG. 2, a system that does not allow for sharing would use a different rule. For example, a different rule might be to only allow an operation to proceed only when the schema component is valid in exactly one subsystem, i.e., only allow matches c, f, g, h, and i from the above to proceed.

As shown in FIG. 2 by decision box 260, in the situation where there are more than two matches between subsystems and schema, the tool would transitively apply the two-match disambiguating rule discussed above in connection with box 255. For example, a three way match having subsystems “A”, “B” and “C” would be matched using the two-match disambiguating rule as follows: “A” and “B” together, then “B” and the results with “C” together.

The tool then terminates at the end condition, box 241 in FIG. 2, assuming no exceptions have been handled earlier.

As one of skill in the art should understand from the teachings of the present invention, while the configuration validation system using “added”, “deprecated”, and “invalidated” is one main concern of the present invention, the meta-data mechanism described herein is also capable to capture other validation information. For example, one important class of validation is checking if certain operations can be performed with a schema component, such as whether or not the subsystem configuration may be “created”, “modified”, or “deleted” on a particular subsystem. In addition, the present invention may be used in a digital rights management scheme, such as to validate certain components are legally installed in a heterogeneous distributed system.

Although the present invention has been described in terms of the preferred embodiments above, numerous modifications and/or additions to the above-described preferred embodiments would be readily apparent to one skilled in the art.

By way of example and not limitation, each subsystem may be customized through a configuration schema that associates with and maps to subsystem features components within the subsystems. In addition to preexisting software and hardware, the configuration schema can include schema components that map to some runtime components within the subsystem in real-time. As a subsystem evolves, a new version of a schema having changes may be distributed. These schema changes may include:

adding a new schema component to a subsystem (viz, adding a new subsystem feature component to a subsystem): the schema component did not previously exist, or it was previously invalidated;

conditionally making a schema component (viz, a subsystem feature component associated with a schema) valid based on certain other subsystem features, e.g., based on actual features installed in the subsystem, or the actual operating system features of the cost, or some other prerequisites;

deprecating a schema component: the schema component (subsystem feature component) is still valid now on the subsystem, but will become invalid in the near future;

invalidating a schema component: the schema component is no longer valid in the subsystem;

changing the allowed values for a schema component;

coordinating changes among subsystems: (1) moving a schema component from one subsystem to another, by invalidating the schema component in one, and adding it to another; (2) sharing a schema component, by adding a schema component to one or more subsystems; (3) unsharing a schema component, by invalidating a schema component in all but one subsystem

It is intended that the scope of the present invention extends to all such modifications and/or additions and that the scope of the present invention is limited solely by the claims set forth below.

What is claimed is:

1. A method for a distributed system having a plurality of subsystems, said method performed within a computer having a processor which executes instructions stored in memory, said method comprising the steps of:
identifying state variables of subsystems in a distributed system, said state variables describing subsystem feature components of the subsystems;
specifying a configuration schema, having schema components, to describe feature components of a subsystem;
matching said schema with said state variables to associate said schema components with said feature components of said subsystems.

2. The method as set forth in claim 1, further comprising the steps of:
storing said state variables as state variable meta-data;
wherein said step of specifying a schema describing feature components of a subsystem comprises the step of identifying any changes in the state variables of said subsystems in the distributed system, and storing said changes in said schema as schema meta-data.

3. The method as set forth in claim 2 wherein:
said step of specifying said schema to identify any changes in the state variables of subsystems in the distributed system comprises identifying the change in said state variables from the addition of at least one component to said subsystems.

4. The method as set forth in claim 2 wherein:
said step of specifying said schema to identify any changes in the state variables of subsystems in the distributed system comprises identifying the change in said state variables from the conditional change of one of said state variables.

5. The method as set forth in claim 2, wherein:
said step of specifying said schema to identify any changes in the state variables of subsystems in the distributed system comprises identifying the change of one of said state variables dynamically, in real-time.

6. The method as set forth in claim 2 wherein:
said step of specifying said schema to identify any changes in the state variables of subsystems in the distributed system comprises identifying the change from the deprecation of one of said state variables.

7. The method as set forth in claim 1, further comprising the steps of:
storing said state variables as state variable meta-data;
said step of specifying a schema describing feature components of a subsystem comprises specifying changes in said schema, according to changes selected from the group consisting of: adding a new component to said schema, conditionally making a schema component valid based on predetermined features in said subsystems, deprecating a schema component, invalidating a schema component, changing the allowed values of a schema component; modifying a schema component and deleting a schema component; and,
storing said changes in said schema as schema meta-data.

8. The method as set forth in claim 7, further comprising the steps of:
specifying changes in said schema by manual input.

9. The method as set forth in claim 1, wherein:
said step of identifying state variables comprises identifying variables that describe said subsystems, selected from the group consisting of operating system name, version number of at least one piece of software or firmware, hardware components in the subsystems, hard drives, memory, IO devices, MAC addresses, Internet addresses, digital signatures and software runtime components.

10. The method as set forth in claim 1, further comprising the steps of:
validating that at least one subsystem of said distributed system matches said schema.

11. The method as set forth in claim 1, further comprising the steps of:
configuring said distributed system to change the subsystem feature components on at least one subsystem when a match is made between said schema component and said state variables of said subsystems.

12. The method as set forth in claim 11, wherein said configuring step comprises:
performing an operation on at least one said subsystem when a match is made between said schema component and said state variables of said subsystems, said operation comprising a operation selected from the group consisting of:
adding a new subsystem feature component to a subsystem,
conditionally making a subsystem feature component associated with said schema valid based on certain other subsystem features installed in the subsystem where said match is found;
deprecating a subsystem feature component;
invalidating a subsystem feature component;
changing the allowed values for a subsystem feature component;
moving a subsystem feature component from one subsystem to another;
sharing a subsystem feature component between subsystems, and
unsharing a subsystem feature component, by invalidating a subsystem feature component in all but one subsystem.

13. The method as set forth in claim 11, further comprising the steps of:
ascertaining whether there is more than one match between said schema components and said state variables;
ascertaining whether the distributed systems allows for two subsystems to share the same subsystem feature components; and,
applying a disambiguating rule for performing said configuration when at least two subsystems share the same schema component.

14. The method as set forth in claim 13, wherein:
said configuration step comprises performing an operation on at least one said subsystem, said operation selected from the group consisting of “added”, “depreciated” and “invalidated”;
said disambiguating rule for performing said configuration operation comprises, for two matching subsystems, A and B, the operation for A being the first ordered pair element below and the operation for B being the second ordered pair element below, comprising the following rule:
{added, added}—added, the configuration operation may be performed on subsystems A and B;
{added, deprecated}—added, the configuration operation may be performed on subsystems A and B;
{added, invalidated}—added, the configuration operation may be performed on subsystems A and B;
{deprecated, added}—added, the configuration operation may be performed on subsystems A and B;
{deprecated, deprecated}—deprecated, the configuration operation may be performed on subsystems A and B, with a warning;
{deprecated, invalidated}—deprecated, the configuration operation may be performed on subsystems A and B;
{invalidated, added}—added, the configuration operation may be performed on subsystems A and B;
{invalidated, deprecated}—deprecated, the configuration operation may be performed on subsystems A and B, with a warning;
{invalidated, invalidated}—invalidated, the configuration operation may not be performed on subsystems A and B.

15. The method according to claim 11, wherein configuring further comprises the steps of:
configuring subsystem feature components on said subsystem in real time.

16. A computer readable storage medium storing software data in the form of computer code, comprising:
an identifying state variables software module for identifying state variables that describe subsystems in a distributed system;
a configuration schema software module to specify a desired configuration schema, having schema components, that describe a subsystem; and,
a matching software module for matching said desired configuration schema with said identified state variables in the subsystems of the distributed system.

17. The invention of claim 16, further comprising:
a validation software module, for making changes to the subsystems of the distributed system and validating whether the identified state variables match the configuration schema.

18. The invention of claim 17, wherein:
said identifying state variables software module comprises data identifying variables that describe said subsystems, said variables selected from the group consisting of operating system name, version number of at least one piece of software or firmware, hardware components in the subsystems, hard drives, memory, IO devices, MAC addresses, Internet addresses, digital signatures and software runtime components;
said configuration schema software module comprises data that specifies changes in said schema, according to changes selected from the group consisting of: adding a new component to said schema, conditionally making a schema component valid based on predetermined features in said subsystems, deprecating a schema component, and invalidating a schema component, changing the allowed values of a schema component; modifying a schema component and deleting a schema component; and,
said validation software module performing an operation on at least one said subsystem when a match is made between said schema component and said state variables of said subsystems, said operation comprising a operation selected from the group consisting of:
adding a new subsystem feature component to a subsystem,
conditionally making a subsystem feature component associated with said schema valid based on certain other subsystem features installed in the subsystem where said match is found;
deprecating a subsystem feature component;
invalidating a subsystem feature component;
changing the allowed values for a subsystem feature component;
moving a subsystem feature component from one subsystem to another;
sharing a subsystem feature component between subsystems, and—
unsharing a subsystem feature component, by invalidating a subsystem feature component in all but one subsystem.

19. A system, within a computer platform, for configuring a distributed system having a plurality of subsystems, said system comprising:
memory storing data;
I/O for inputting and outputting data;
a plurality of software function modules residing in said memory;
a processor cooperating with said memory and I/O for processing instructions and data from said memory, said I/O and said function modules;
an identifying state variables software function module in said memory for identifying state variables that describe subsystems in a distributed system;
a configuration schema software function module in said memory to specify a desired configuration schema, having schema components, that describe a subsystem having feature components; and,
a matching software function module in said memory for matching said desired configuration schema with said identified state variables in the subsystems of the distributed system.

20. The system according to claim 19, further comprising:
a validation software function module in said memory, for making changes to the subsystems of the distributed system and validating whether the identified state variables match the configuration schema.

21. The system according to claim 20, wherein:
said configuration schema module specifies a schema that specifying changes in the feature components in the subsystems of the distributed system, according to changes selected from the group consisting of: adding a new component to said schema, conditionally making a schema component valid based on predetermined features in said subsystems, deprecating a schema component, and invalidating a schema component, changing the allowed values of a schema component; modifying a schema component and deleting a schema component.

22. The system according to claim 19, wherein:
said identifying state variables software function module in said memory for identifying state variables that describe subsystems in the distributed system comprises identifying variables that describe said subsystems, selected from the group consisting of operating system name, version number of at least one piece of software or firmware, hardware components in the subsystems, hard drives, memory, IO devices, MAC addresses, Internet addresses, digital signatures and software runtime components.

23. The system according to claim 20, wherein:
said validation software function module, for making changes to the subsystems of the distributed system and validating whether the identified state variables match the configuration schema, configures by a configuring operation said distributed system, to change the subsystem feature components on at least one subsystems, when a match is made between said schema component and said state variables of said subsystems by said matching software function module.

24. The system according to claim 23, wherein:
said validation function module has the configuring operation comprising a operation selected from the group consisting of: adding a new subsystem feature component to a subsystem; conditionally making a subsystem feature component associated with said schema valid based on certain other subsystem features installed in the subsystem where said match is found; deprecating a subsystem feature component; invalidating a subsystem feature component; changing the allowed values for a subsystem feature component; moving a subsystem feature component from one subsystem to another; sharing a subsystem feature component between subsystems, and unsharing a subsystem feature component, by invalidating a subsystem feature component in all but one subsystem.

25. The system according to claim 23, further comprising:
a disambiguating rule software function module for ascertaining whether there is more than one match between said schema components and said state variables, said disambiguating rule software module ascertaining whether the distributed systems allows for two subsystems to share the same subsystem feature components and, applying a disambiguating rule for performing said configuration by said validation software function module when at least two subsystems share the same schema component.

26. The system according to claim 25, wherein:
said disambiguating rule software function module applying said disambiguating rule for performing said configuration operation by said validation software function module comprises, for two matching subsystems, A and B, the configuration operation for A being the first ordered pair element below and the configuration operation for B being the second ordered pair element below, the following rule:
{added, added}—added, the configuration operation may be performed on subsystems A and B;
{added, deprecated}—added, the configuration operation may be performed on subsystems A and B;
{added, invalidated}—added, the configuration operation may be performed on subsystems A and B;
{deprecated, added}—added, the configuration operation may be performed on subsystems A and B;
{deprecated, deprecated}—deprecated, the configuration operation may be performed on subsystems A and B, with a warning;
{deprecated, invalidated}—deprecated, the configuration operation may be performed on subsystems A and B;
{invalidated, added}—added, the configuration operation may be performed on subsystems A and B;
{invalidated, depreciated}—deprecated, the configuration operation may be performed on subsystems A and B, with a warning;
{invalidated, invalidated}—invalidated, the configuration operation may not be performed on subsystems A and B.
